(19) United States
(12) Patent Application Publication
(10) Pub. No.: US 2002/0111417 A1
(43) Pub. Date: Aug. 15, 2002

(54) Fluoroelastomer films prepared by peroxide curing a water-borne fluoroelastomer coating

(75) Inventors: Pavel Kirochko, Bolivar, OH (US); James G. Kreiner, Green, OH (US)

Correspondence Address: RENNER, KENNER, GREIVE, BOBAK, TAYLOR & WEBER, FOURTH FLOOR, FIRST NATIONAL TOWER, AKRON, OH, 44308, US

(73) Assignee: Lauren International, Inc.

(21) Appl. No.: 09/735,750

(22) Filed: Dec. 13, 2000

(51) Int. Cl. C08L 27/12

(52) U.S. Cl. 524/546; 525/387

(57) ABSTRACT

A process for forming a cured fluoroelastomer film comprising the steps of providing a fluoroelastomer latex, adding an organic peroxide curing agent and coagent to the latex to form a curable coating composition, forming a film with the curable coating composition, and curing the film at elevated temperature.

### BACKGROUND OF THE INVENTION

Peroxides have been used to cure elastomers. For example, unsaturated elastomers such as polybutadiene or ethylene-propylene-diene terpolymers have been cured with organic peroxides. This curing takes place while the elastomers are in their solid state, and usually includes curing under pressure such as in an autoclave, or by compression or injection molding. In many situations, the curing takes place in an oxygen-reduced environment so as to prevent premature degradation of the peroxide.

Attempts have been made to employ organic peroxides to cure elastomeric films prepared from latexes. This has not proved successful because an incomplete cure results as evidenced by a tacky surface, which is believed to be caused by the decomposition of the organic peroxide in the presence of oxygen. For example, when films of nitrile rubber are prepared from nitrile rubber latexes and cured with benzoyl peroxide, the resultant film has a tacky surface, indicating an incomplete cure.

### SUMMARY OF INVENTION

In general the present invention provides a process for forming a cured fluoroelastomer film comprising the steps of providing a fluoroelastomer latex, adding an organic peroxide curing agent and coagent to the latex to form a curable coating composition, forming a film with the curable coating composition, and curing the film at elevated temperature.

The present invention also includes a curable fluoroelastomer coating composition comprising a fluoroelastomer latex, from about 1 to about 10 parts by weight of a peroxide curing agent per 100 parts by weight fluoroelastomer, from about 1 to about 10 parts by weight of a peroxide cure coagent per 100 parts by weight fluoroelastomer.

The present invention further includes a fluoroelastomer film prepared by the steps comprising providing a fluoroelastomer latex, adding an organic peroxide curing agent and coagent to the latex to form a curable coating composition, forming a film with the curable coating composition, and curing the film at elevated temperature.

It has now been discovered that films prepared from fluoroelastomer latexes can be cured with peroxide curing agents. This surprising discovery has provided improved fluoroelastomer cured films that do not suffer from the disadvantages associated with the elastomeric films that have been prepared by curing other elastomer latexes, such as nitrile rubber latex, with organic peroxides. These films advantageously have an improved chemical resistance. Also, it has surprisingly been discovered that the pot life of fluoroelastomer coating compositions, which include a peroxide curative, is improved.

### PREFERRED EMBODIMENT FOR CARRYING OUT THE INVENTION

Water-borne fluoroelastomer coating compositions are cured with peroxides to form cured films or other articles that have improved chemical resistance. Preferably, the improved film is obtained by adding a peroxide to a fluoroelastomer latex to form a coating composition, forming the coating composition into a film, and then curing the film. Preferably, a coagent is used in conjunction with the peroxide curative.

The fluoroelastomer latexes are aqueous dispersions of fluoroelastomers. These latexes should contain, on a solids basis, from about 10 to about 80 percent by weight fluoroelastomer, preferably from about 60 to about 73 percent by weight fluoroelastomer, and even more preferably from about 63 to about 70 percent by weight fluoroelastomer. The term fluoroelastomer latex will refer to those compositions that include one or more, i.e., a mixture, of various fluoroelastomers.

The fluoroelastomer latex may contain one or more fluoroelastomers that are obtained by polymerizing copolymerizable fluorine-containing monomers. These monomers may include, but are not limited to, tetrafluoroethylene, chlorotrifluoroethylene, vinyl fluoride, vinylidene fluoride, hexafluoropropylene, and perfluoroether. Additionally, these monomers may be copolymerized with α-olefins such as ethylene and propylene. Examples of specific copolymers include copolymers of vinylidene fluoride and hexafluoropropylene and terpolymers of vinylidene fluoride, hexafluoropropylene and tetrafluoroethylene. The term copolymers will refer to polymers containing more than one distinct monomer and will therefore include terpolymers, tetrapolymers, and greater copolymers. These copolymer latexes are well known and can be obtained under the tradename Technoflon™TN Latex (Ausimont S.p.A.;Milan, Italy); Viton™ VTR-7487 Latex (Dupont Dow Elastomers, LLC; Wilmington, Del.); or GL-152, GL-252, and GLS-213 (Daikin Ind. Ltd; Osaka, Japan).

In addition to the conventional fluoroelastomers described above, the fluoroelastomer latex used in the coating may contain those fluoroelastomers that have been specifically designed for solid-state curing with an organic peroxide. These modified fluoroelastomers are synthesized by polymerizing bromine-containing olefins and/or iodine-containing olefins in conjunction with fluorine-containing monomers, as well as other olefins. These modified-fluoroelastomers are well known in the art as described in U.S. Pat. Nos. 4,529,759 and 4,694,045, which are incorporated herein by reference.

Additionally, the fluoroelastomers may include elastomers with bromine-containing olefins or iodine-containing olefins, including those and that contain iodine atoms at the ends of the polymer chains. This can be accomplished by conducting a radical polymerization of the monomers in the presence of an iodinated compound. These modified-fluoroelastomers and the methods of their formation are known as described in U.S. Pat. Nos. 4,948,852 and 4,948,853, which are incorporated herein by reference. Although the use of the modified-fluoroelastomers has many benefits, their use is not required because, as discussed above, conventional fluoroelastomer latexes can be cured according to this invention.

Any peroxide compound that can be employed to cure solid elastomers can be used to cure latex-based compositions of this invention. Preferred peroxides include organic peroxides such as dialkyl peroxides, peroxyesters, diacyl peroxides, ketone peroxides, peroxydicarbonates, hydroperoxides, peroxyketals, and mixtures thereof.

Non-limiting examples of alkyl and dialkyl peroxides include dicumyl peroxide, 2,5-dimethyl-2,5-di-(t-butylperoxy)hexane, t-butyl cumyl peroxide, α,α′-bis(t-butylperoxy)diisopropylbenzene, di-t-butyl peroxide, and 2,5-dimethyl-2,5-di-(t-butylperoxy)hexyne-3.

Non-limiting examples of peroxyesters include α-cumyl peroxy-neodecanoate, 1,1-dimethyl-3-hydroxy-butyl peroxyneoheptanoate, α-cumyl peroxy-heptanoate, t-amyl peroxyneodecanoate, t-amyl peroxypivalate, t-butyl peroxyneodecanoate, t-butyl peroxypivalate, 1,1-dimethyl-3-hydroxy-butyl peroxy 2-ethylhexanoate, 2,5-dimethyl 2,5 di(2-ethylhexanoylperoxy)hexane, t-amyl peroxy 2-ethylhexanoate, t-butyl peroxy 2-ethylhexanoate, t-butyl peroxy isobutyrate, t-butyl peroxyacetate, t-amyl peroxyacetate, t-butyl perbenzoate, t-amyl perbenzoate, di-t-butyl diperoxyphthalate, oo-t-butyl o-isopropyl monoperoxycarbonate, 2,5-dimethyl 2,5-di(benzoylperoxy)hexane, oo-t-butyl 1-(2-ethylhexyl)monoperoxycarbonate, oo-t-amyl o-(2-ethylhexyl) monoperoxycarbonate.

Non-limiting examples of diacyl peroxides include diisononanoyl peroxide, decanoyl peroxide, lauroyl peroxide, succinic acid peroxide, and benzoyl peroxide.

Non-limiting examples of peroxydicarbonates include di(n-propyl) peroxydicarbonate, di(sec-butyl)peroxydicarbonate, and di(2-ethylhexyl)peroxydicarbonate.

An example of a ketone peroxide includes 2,4-pentanedione peroxide.

Non-limiting examples of hydroperoxides include 2,5-dihydroperoxy-2,5-dimethylhexane, cumene hydroperoxide, t-butyl hydroperoxide, and t-amyl hydroperoxide.

Non-limiting examples of peroxyketals include n-butyl-4,4-di-(t-butylperoxy)valerate, 1,1-di-(t-butylperoxy)-3,3,5-trimethyl-cyclohexane, 1,1-di-(t-butylperoxy)-cyclohexane, 1,1-di-(t-amylperoxy)-cyclohexane, 2,2-di-(t-butylperoxy)-butane, ethyl-3,3-di-(t-butylperoxy)-butyrate, t-butyl peroctoate, 2,2-di-(t-amylperoxy)propane, and ethyl 3,3-di-(t-amylperoxy)-butyrate.

Preferably, the peroxide curative is employed within a cure system that also includes a coagent. These coagents can include any of the coagents that are conventionally employed to cooperate with a peroxide curative for polymer curing. Typically, these coagents are polyunsaturated compounds. Non-limiting examples of these compounds include triallyl isocyanurate, triallyl cyanurate, trivinyl isocyanurate, trimethallyl isocyanurate, tris(diallylamine)-s-triazine, triallyl phosphite, N,N-diallyl acrylamide, hexaallyl phosphoramide, N,N,N′N′-tetra allyl terephthalamide, N,N,N′,N′-tetra allyl malonamide, 2,4,6-trivinyl methyltrisiloxane, and tri(5-norbornene-2-methylene)cyanurate, or any other coagents used for peroxide curing of polymers, or mixtures thereof.

In addition to the foregoing ingredients, other additives that are conventionally employed in preparing curable water-borne fluoroelastomer compositions can optionally be employed.

Fillers that may be employed include carbon black, mineral fillers such as clays, synthetic silicates, whiting, and barytes, glass micro beads, and chopped fibers. Additionally, fillers that modify resistivity can be used. Examples of these fillers include metal powders and graphite.

Other additives that can be used include those additives that may act as cure activators and acid acceptors. These additives may include metal oxides such as zinc oxide or metal hydroxides such as calcium hydroxide. Other additives still include viscosity modifiers, surfactants, pigments and dyes, and biostats.

The amount of peroxide curing agent employed is typically a function of the reactivity of the peroxide compound. Therefore, exact amounts of curative cannot be set forth with any great degree of certainty other than to say that those skilled in the art will be able to readily determine, without undue experimentation, an effective amount of curative. Nonetheless, from about 1 to about 10 parts by weight net curative per 100 parts by weight fluoroelastomer (based on the solids content of the latex) is typically employed. Preferably, from about 3 to about 9 parts by weight net curative per 100 parts by weight fluoroelastomer, and even more preferably from about 5 to about 7 parts by weight net curative per 100 parts by weight fluoroelastomer, is employed. Those skilled in the art appreciate that peroxide curatives are usually blended with a safety extender or additive such as water, silicone oil, silicates, carbonates, and the like. Therefore, the foregoing amounts have been reported as weight net curative with reference to the peroxide compound only; e.g., without water.

The amount of coagent that is employed will typically vary based upon the nature of the coagent and the specific peroxide curative employed. Nonetheless, the amount of coagent added to the fluoroelastomer latex is generally from about 1 to about 10 parts by weight net coagent per 100 parts by weight fluoroelastomer (based upon the solids content of the latex). Preferably, from about 5 to about 7 parts by weight net coagent per 100 parts by weight fluoroelastomer is employed. The coagents, like the peroxides, are reported as weight net coagent because they may likewise include an extender such as silicates and carbonates.

The amount of other additives employed within the fluoroelastomer compositions of this invention can vary based upon the ultimate properties desired in the composition or film. Those skilled in the art will be able to select these desired amounts without undue experimentation.

The curable fluoroelastomer coating composition can be prepared by mixing the peroxide curing agent, preferred coagent, and optional other additives with the fluoroelastomer latex. This mixing or dispersing can take place within devices or apparatus that are well known to those skilled in the art. In one embodiment, the mixing can take place within a ball mill.

The curable-fluoroelastomer coating composition may be prepared under ambient conditions, including ambient temperature and atmospheric pressure. The coating composition should not be heated above the decomposition temperature of the peroxide being employed.

The curable-fluoroelastomer coating composition of this invention advantageously have a useful pot-life that is greater than about 9 months. Useful pot-life refers to the time from the preparation of the curable composition, i.e., the addition of the peroxide, to time when a cured film can be made without deleterious impact on the engineering properties of the film.

A wet-fluoroelastomer film, which is a film that has not dried or cured, may be prepared by using a number of techniques that are well known to those skilled in the art. Typically, these films are applied to a substrate. For example, the curable-fluoroelastomer coating composition may be sprayed, drawn down, brushed, or dipped to form a film. These techniques are well known to those skilled in the art of making elastomeric films and coatings.

Once a wet film has been prepared, the film is preferably allowed to dry. This drying can occur at ambient temperature and atmospheric pressure. Generally, the length of time required to dry the film is a function of the film's thickness. Typically, an average film having a thickness of about 10 μm requires about 20 to about 30 minutes to dry.

The dried film should then be cured at elevated temperatures. The temperature required to cure the film will likewise vary depending on the peroxide and/or coagent employed. It is believed that the peroxide decomposes to effect the cure and therefore those skilled in the art can estimate a useful cure temperature based upon the half life of the peroxide. Typically, an average cure time is about 1 hour at about 130 to about 150° C.

The coating compositions of this invention can be used to coat various substrates including metal, rubber, plastic, concrete, or fabrics. As a result, these coatings may be useful in the under-the-hood automotive, agriculture, petro and electrochemical, construction, electric and electronics, marine, pulp and paper, aerospace, and military industries. More specifically, the compositions of this invention can be used to coat rubber rolls or printing rolls. They can also be used to coat rubber for use in RFI and EMI shielding, or coat certain materials and components within fuel cells and batteries. Fabrics can be coated for suits or tarps used in chemical clean-up and the like. Still further, chemical storage tanks can be coated, as well as the structures that support these tanks.

In order to demonstrate the practice of the present invention, the following examples have been prepared and tested as described in the General Experimentation Section disclosed hereinbelow. The examples should not, however, be viewed as limiting the scope of the invention. The claims will serve to define the invention.

### GENERAL EXPERIMENTATION

Sample 1 (Control)

A fluoroelastomer latex (1000 g) was mixed with carbon black (100 g) in a ball mill for 24 hours. The fluoroelastomer latex was obtained under the tradename Viton VTR-7487 Latex (Du Pont Dow Elastomers), and was characterized by having about 69% solids with the elastomer being a terpolymer of hexafluoropropylene, vinylidene fluoride, and tetrafluoroethylene, with a fluorine content of about 68%. The carbon black was designated N-991 UP according to ASTM designation D-1765-82a. A hydrolyzed, stabilized amino silane curative (56 g),whichwas obtained under the tradename Hydrosil™ 2776 (Sivento Inc.; Piscataway, N.J.), was manually stirred into the fluoroelastomer latex/carbon black dispersion. Within about 1 hour, films were prepared by pouring the liquid dispersion onto a Mylar™ (Du Pont) substrate, and then drawing the liquid down to a uniform thickness. The resulting film was allowed to dry at ambient temperature. After drying, the film was subsequently cured in an oven at 100° C. for one hour.

Physical tests were conducted according to ASTM D-412-97. Acid resistance was tested by measuring the swelling of the film in concentrated sulfuric acid and hydrochloric acids, each at room temperature for about 24 hours. Water resistance was tested by determining the swelling of the film in boiling water for 5 days. The results of these tests are shown in Table I. The liquid dispersion, including the curative, was tested for pot life by aging at room temperature within a closed container for several months. During this time, aging of the compound was followed by determining the Brookfield viscosity of the liquid and the physical properties of freshly cured films at regular intervals. The results of these aging tests are shown in Table II.

Sample 2

A fluoroelastomer latex similar to that employed in Sample 1 (1000 g) was mixed with benzoyl peroxide (net 42 g), triallyl isocyanurate (net 42 g), and zinc oxide (42 g) within a ball mill for 24 hours. Films were prepared and dried as in Sample 1. The dried films were then cured at 130° C. for 1 hour. Physical testing was conducted as described in Sample 1.

Sample 3

A fluoroelastomer latex blend was prepared by mixing the fluoroelastomer latex employed in Sample 1 with a second fluoroelastomer latex. The second fluoroelastomer latex included about 69% solids and the fluoroelastomer was a tetrapolymer containing units deriving from hexafluoropropylene, vinylidene fluoride, tetrafluoroethylene, and a bromine-containing olefin. The tetrapolymers contained about 70% by weight fluorine. The blend contained about 20% by weight of the fluoroelastomer latex from Sample 1 and about 80% by weight of the second fluoroelastomer latex. This blended-fluoroelastomer latex was mixed with the same ingredients, prepared into a film, dried, and cured in a similar fashion to the latex of Sample 2.

Sample 4

A film was prepared in a similar fashion to Sample 2. The fluoroelastomer latex (1000 g) that was employed was characterized by having about 69% solids with the elastomer being a terpolymer of hexafluoropropylene, vinylidene fluoride, and tetrafluoroethylene, included iodine cure sites, and contained about 70% fluorine. This latex was mixed with benzoyl peroxide (net 42 g) and triallylisocyanurate (net 42 g) (no carbon black was added), prepared into a film, dried, and cured in a similar fashion to the latex of Sample 2.

Sample 5

The fluoroelastomer latex of Sample 4 was mixed with 2,5-dimethyl-2,5-di(t-butylperoxy)hexane (net 42 g) and triallyl isocyanurate (net 42 g) in a ball mill for 24 hours. The 2,5-dimethyl-2,5-di(t-butylperoxy)hexane was obtained under the tradename Luperco™ 101-XL (Akzo Chemical Co.). A film was prepared as in Sample 1 and dried at ambient temperature. The dried film was then cured at about 150° C. for about one hour. Physical testing was performed as with Sample 1.

Sample 6

The fluoroelastomer latex of Sample 4 was mixed with dicumyl peroxide (net 42 g) and triallyl isocyanurate (net 42 g) in a ball mill for 24 hours. The dicumyl peroxide was obtained under the tradename DiCup 40C (Hercules). Films were prepared, dried, cured, and tested in a similar fashion to Sample 5.

TABLE I

| Samples | 1 | 2 | 3 | 4 | 5 | 6 |
|---|---|---|---|---|---|---|
| 100% Modulus | 1.64 | 1.86 | 2.01 | 1.95 | 1.88 | 1.92 |
| (MPa) | | | | | | |
| Tensile | 8.590 | 9.383 | 7.701 | 8.032 | 6.467 | 6.908 |
| Strength | | | | | | |
| (MPa) | | | | | | |
| Elongation at | 654 | 445 | 389 | 397 | 601 | 539 |
| Break (%) | | | | | | |
| Swelling in | 28.5 | 2.55 | 3.11 | 2.87 | — | — |
| H₂SO₄ (%) | | | | | | |
| Swelling in | 13.3 | 5.15 | 1.25 | 1.01 | — | — |
| HCl (%) | | | | | | |
| Swelling in | 23.0 | 7.3 | 6.8 | 5.9 | — | — |
| H₂O (%) | | | | | | |

The curable latex compositions of Samples 1 and 2 were also used to conduct ageing or pot life experiments. Specifically, the composition of Sample 1 was stored in a sealed container at room temperature for 4 months, prepared into a film, dried, and cured. The viscosity of the composition and the tensile properties of the cured film were determined. The composition of Sample 2 was likewise stored in a sealed container at room temperature, but films were prepared, dried, and cured after 6 months and 9 months. The viscosity of the composition and the tensile properties of the film were likewise determined. The results of the testing are set forth in Table II.

TABLE II

| | | 100% | | |
|---|---|---|---|---|
| | Brookfield | Modulus | Tensile | Elongation @ |
| | Viscosity (cps) | (MPa) | Strength (MPa) | Break (%) |
| Sample 1 | 83 | 1.66 | 8.59 | 654 |
| (initial) | | | | |
| 4 months | 737 | 1.64 | 8.22 | 632 |
| Sample 2 | 101 | 1.75 | 6.9 | 653 |
| (initial) | | | | |
| 6 months | 103 | 1.83 | 7.15 | 606 |
| 9 months | 122 | 1.87 | 5.73 | 628 |

While the best mode and preferred embodiment of the invention have been set forth in accord with the Patent Statues, the scope of this invention is not limited thereto, but rather is defined by the attached claims. Thus, the scope of the invention includes all modifications and variations that may fall within the scope of the claims.

What is claimed is:

1. A process for forming a cured fluoroelastomer film comprising the steps of:
providing a fluoroelastomer latex;
adding an organic peroxide curing agent and coagent to the latex to form a curable coating composition;
forming a film with the curable coating composition; and
curing the film at elevated temperature.

2. The process of claim 1, where the organic peroxide curing agent is a dialkyl peroxide, peroxyester, diacyl peroxide, ketone peroxide, peroxydicarbonate, hydroperoxide, peroxyketal, or mixture thereof.

3. The process of claim 2, where the dialkyl peroxide curing agent is a dicumyl peroxide, 2,5-dimethyl-2,5-di-(t-butylperoxy)hexane, t-butyl cumyl peroxide, α,α′-bis (t-butylperoxy)diisopropylbenzene, di-t-butyl peroxide, 2,5-dimethyl-2,5-di-(t-butylperoxy)hexyne-3, or a mixture thereof.

4. The process of claim 2, where the peroxyester curing agent is α-cumyl peroxy-neodecanoate, 1,1-dimethyl-3-hydroxy-butyl peroxyneoheptanoate, α-cumyl peroxy-heptanoate, t-amyl peroxyneodecanoate, t-amyl peroxypivalate, t-butyl peroxyneodecanoate, t-butyl peroxypivalate, 1,1-dimethyl-3-hydroxy-butyl peroxy 2-ethylhexanoate, 2,5-dimethyl 2,5 di(2-ethylhexanoylperoxy)hexane, t-amyl peroxy 2-ethylhexanoate, t-butyl peroxy 2-ethylhexanoate, t-butyl peroxy isobutyrate, t-butyl peroxyacetate, t-amyl peroxyacetate, t-butyl perbenzoate, t-amyl perbenzoate, di-t-butyl diperoxyphthalate, oo-t-butyl o-isopropyl monoperoxycarbonate, 2,5-dimethyl 2,5-di(benzoylperoxy)hexane, oo-t-butyl 1-(2-ethylhexyl)monoperoxycarbonate, oo-t-amyl o-(2-ethylhexyl) monoperoxycarbonate, or a mixture thereof.

5. The process of claim 2, where the diacylperoxide curing agent is diisononanoyl peroxide, decanoyl peroxide, lauroyl peroxide, succinic acid peroxide, benzoyl peroxide, or mixture thereof; and, where the peroxydicarbonate curing agent is di(n-propyl)peroxydicarbonate, di(sec-butyl)peroxydicarbonate, di(2-ethylhexyl)peroxydicarbonate, or a mixture thereof.

6. The process of claim 2, where the ketone peroxide curing agent is 2,4-pentanedione peroxide; and, where the hydroperoxide curing agent is 2,5-dihydroperoxy-2,5-dimethylhexane, cumene hydroperoxide, t-butyl hydroperoxide, t-amyl hydroperoxide, or a mixture thereof.

7. The process of claim 2, where the peroxyketal curing agent is n-butyl-4,4-di-(t-butylperoxy)valerate, 1,1-di-(t-butylperoxy)-3,3,5-trimethyl-cyclohexane, 1,1-di-(t-butylperoxy)-cyclohexane, 1,1-di-(t-amylperoxy)-cyclohexane, 2,2-di-(t-butylperoxy)-butane, ethyl-3,3-di-(t-butylperoxy)-butyrate, t-butyl peroctoate, 2,2-di-(t-amylperoxy)propane, ethyl 3,3-di-(t-amylperoxy)-butyrate, or a mixture thereof.

8. The process of claim 1, where the coagent is a polyunsaturated compound.

9. The process of claim 8, where the coagent is triallyl isocyanurate, triallyl cyanurate, trivinyl isocyanurate, trimethallyl isocyanurate, tris(diallylamine)-s-triazine, triallyl phosphite, N,N-diallyl acrylamide, hexa-allyl phosphoramide, N,N,N′N′-tetra allyl terephthalamide, N,N,N′,N′-tetra allyl malonamide, 2,4,6-trivinyl methyltrisiloxane, and tri(5-norbornene-2-methylene)cyanurate, or mixtures thereof.

10. The process of claim 1, where the fluoroelastomer contains at least one unit deriving from a bromine-containing olefin, an iodine-containing olefin, or both.

11. The process of claim 1, where the fluoroelastomer is a copolymer, terpolymer, or tetrapolymer having polymeric units deriving from tetrafluoroethylene, chlorotrifluoroethylene, vinyl fluoride, vinylidene fluoride, hexafluoropropylene, or various combinations or subcombinations thereof, and optionally bromine-containing olefins, iodo moieties, or combinations or subcombinations thereof.

12. The process of claim 11, where the fluoroelastomer is a terpolymer of vinylidene fluoride, hexafluoropropylene, and tetrafluoroethylene.

13. The process of claim 11, where the fluoroelastomer is a tetrapolymer of vinylidene fluoride, hexafluoropropylene, tetrafluoroethylene and bromine-containing olefin.

14. The process of claim 11, where the fluoroelastomer latex contains from about 60 to about 73 percent by weight fluoroelastomer on a solids basis.

15. The process of claim 1, where said step of adding an organic peroxide curing agent includes adding from about 1 to about 10 parts by weight net curing agent per 100 parts by weight fluoroelastomer.

16. The process of claim 1, where step of adding a coagent includes adding from about 1 to about 10 parts by weight net coagent per 100 parts by weight fluoroelastomer.

17. The process of claim 1, further comprising the step of drying the film.

18. The process of claim 1, where said step of curing occurs at about 130° to about 150° C. for about 1 hour.

19. A curable fluoroelastomer coating composition comprising:
a fluoroelastomer latex, from about 1 to about 10 parts by weight of a peroxide curing agent per 100 parts by weight fluoroelastomer, from about 1 to about 10 parts by weight of a peroxide cure coagent per 100 parts by weight fluoroelastomer.

20. A fluoroelastomer film prepared by the steps comprising:
providing a fluoroelastomer latex;
adding an organic peroxide curing agent and coagent to the latex to form a curable coating composition;
forming a film with the curable coating composition; and
curing the film at elevated temperature.
